(19) United States
(12) Patent Application Publication
(10) Pub. No.: US 2005/0060467 A1
(43) Pub. Date: Mar. 17, 2005

(54) Remote docking station device

(76) Inventor: Brian C. Wieck, Sioux City, IA (US)

Correspondence Address: GATEWAY, INC.;ATTN: SCOTT CHARLES RICHARDSON, 610 GATEWAY DRIVE, MAIL DROP Y-04, N. SIOUX CITY, SD, 57049, US

(21) Appl. No.: 10/646,135

(22) Filed: Aug. 22, 2003

(51) Int. Cl. G06F 13/00

(52) U.S. Cl. 710/303

(57) ABSTRACT

A remote docking station which has a remote docking station body is disclosed. Within the remote docking station body, there is a power converter having an input side, which is adapted to receive electrical power input from a power supply via a power input cable and a power input interface, and an output side configured to deliver electrical power at a desired power level to a computer via an output connector interface and a multipurpose interface cable. The remote docking station has at least one peripheral connector interface configured to receive input from a peripheral device. The peripheral connector interface is in electrical communication with the output connector interface, such that electrical signals from the peripheral connector interface pass to the output connector interface. The multipurpose interface cable connects the output connector interface to the computer, thus the multipurpose interface cable delivers electrical power and electric signals from a peripheral device to the computer. The multipurpose interface cable end may connect to a computer, such as a portable computer, via a single multipurpose connection interface or a plurality of conventional connection interfaces.

### FIELD OF THE INVENTION

The present invention relates to a remote docking station device, and more specifically to a remote docking station that consolidates a power converter and at least one input for a peripheral computing device into a single unit.

### BACKGROUND OF THE INVENTION

Various remote docking stations are known and utilized for numerous purposes. Some conventional docking stations consolidate the number of inputs for a computer into a docking station, but such devices do not incorporate the power converter, commonly an AC adapter, of the computer. Furthermore, many such conventional docking stations do not eliminate clutter of cables and wires on the desktop of the user.

U.S. Pat. No. 6,169,655, issued to Helot, discloses a computer docking drawer. In one embodiment, a standard notebook computer which has parallel tracks on its bottom portion is slid into a drawer which has corresponding platform members on the docking drawer. Once the notebook computer is slid into position, a docking connector on a bottom side of the notebook computer interfaces with a docking connector on a docking platform which rests in the drawer. Once the notebook computer is interfaced, a cable connects the docking platform to an expansion module which can rest on a desktop. The expansion module has ports or other interfaces for coupling to a full-size keyboard, network resources, and peripheral devices, such as a printer, CD-ROM, and floppy disk drive. The docking drawer enables the notebook computer to be removed from the desktop space, but there are still numerous wires and cables cluttered on the desktop which are connected to the expansion module. Furthermore, the numerous cables and wires of the peripheral devices are not consolidated into a single cable, nor are the numerous cables and wires consolidated into a power adapter

U.S. Pat. No. 6,324,606, issued to Lenchian et al., discloses a cable which couples a portable computer to a docking station in order to provide access to resources for use with the portable computer such as a disk drive, CD-ROM drive, or other hard drive. The docking cable has a plurality of lines to communicate low voltage signals between the portable computer and the docking station, and therefore can communicate data. The docking cable further comprises a locking mechanism, controllable by software, which selectively locks the portable computer to the docking cable such that the computer cannot be removed until the computer is prepared for undocking. The invention discloses a single communication cable for allowing a number of peripheral devices on a docking station to communicate with a computer, but the invention does not disclose any means of reducing the number of wires and cables for the computer system. Furthermore, the docking cable does not serve as a power adapter.

U.S. Pat. No. 6,407,914 discloses a docking system for connecting a number of peripheral devices to a portable computer. The docking system has a receiving tray adapted to receive a portable computer and which may communicate with the portable computer. The system has a remote cable dock which interfaces with a plurality of peripheral devices, such as monitors, mice, keyboards, disk drives, digital cameras, and more. An interface cable connects to the receiving tray or directly to a portable computer via a tray connector on one end of the interface cable. The other end of the interface cable connects to the remote cable dock. If the user desires to have a peripheral device closer to himself or herself, the user can also utilize the tray connector, in addition to, or instead of the remote cable dock, to connect numerous peripheral devices. The tray connector has at least one auxiliary connector disposed on its surface to interface with at least one peripheral device. The auxiliary connectors may be of any number, combination or type such as a PS2, USB, serial, parallel, IEEE 1394, audio input or output connectors. When the user connects a plurality of peripheral devices to the remote cable dock or the tray connector, the immediate area will be cluttered from all the cables and devices. Because the peripheral devices will likely be needed on the desktop, the desktop will likely be cluttered.

Therefore, it would be advantageous to provide a remote docking station for consolidating a plurality of input cables for peripheral computing devices into a single unit in combination with a power converter.

### SUMMARY OF THE INVENTION

In light of the above background, it is an object of the present invention to provide a remote docking station for consolidating one or more input cables for peripheral computing devices into a single unit with a power converter.

The present invention is a remote docking station which has a remote docking station body. Within the remote docking station body, there is a power converter. The power converter has an input side, which is adapted to receive electrical power input from a power supply via a power input cable and a power input interface. The power converter has an output side, which is configured to deliver electrical power at a desired power level to a computer via an output connector interface and a multipurpose interface cable.

The remote docking station also has at least one peripheral connector interface, configured to receive input from a peripheral computing device. Peripheral connector interfaces are used to connect peripheral devices, such as keyboards, scanners, printers, pointing devices, microphones, speakers, video displays, or digital cameras, to the computer. The peripheral connector interface or interfaces can be any number or combination of network inputs, modem inputs, serial inputs, parallel inputs, universal serial bus (USB) inputs, PS2 inputs, IEEE 1394 inputs, video inputs, video outputs, audio inputs and or audio outputs, or any other type of input configuration. The peripheral connector interface or interfaces are in electrical communication with the output connector interface, such that electrical signals from each peripheral connector interface pass to the output connector interface.

As mentioned above, the multipurpose interface cable connects the output connector interface to a computer, such as a portable computer. Thus, the multipurpose interface cable carries electrical signals for peripheral computing devices and electrical power from the remote docking station to the computer. The multipurpose interface cable is configured to connect to the output-connector interface at a first multipurpose interface cable end and configured to connect to the computer at a second multipurpose interface cable end. The second multipurpose interface cable end may connect to the computer via a single multipurpose connection interface or a plurality of conventional connection interfaces.

Other features and advantages of the invention will be apparent from the following detailed description taken in conjunction with the following drawings.

### BRIEF DESCRIPTION OF THE DRAWINGS

FIG. 1 is a block diagram of a remote docking station illustrating an overview of the present invention.

FIG. 2A is a first perspective view of a remote docking station in accordance with the present invention.

FIG. 2B is a second perspective view of a remote docking station in accordance with the present invention.

FIG. 3 illustrates a power input cable in accordance with the present invention.

FIG. 4A illustrates a multipurpose interface cable in accordance with the present invention having a multipurpose connection interface.

FIG. 4B illustrates a multipurpose interface cable in accordance with the present invention having a plurality of conventional connection interfaces.

FIG. 5 illustrates a multipurpose interface cable in accordance with the present invention having auxiliary input interfaces.

### DETAILED DESCRIPTION OF THE INVENTION

While this invention is susceptible of embodiments in many different forms, there is shown in the drawings and will herein be described in detail preferred embodiments of the invention with the understanding that the present disclosure is to be considered as an exemplification of the principles of the invention and is not intended to limit the broad aspect of the invention to the embodiments illustrated.

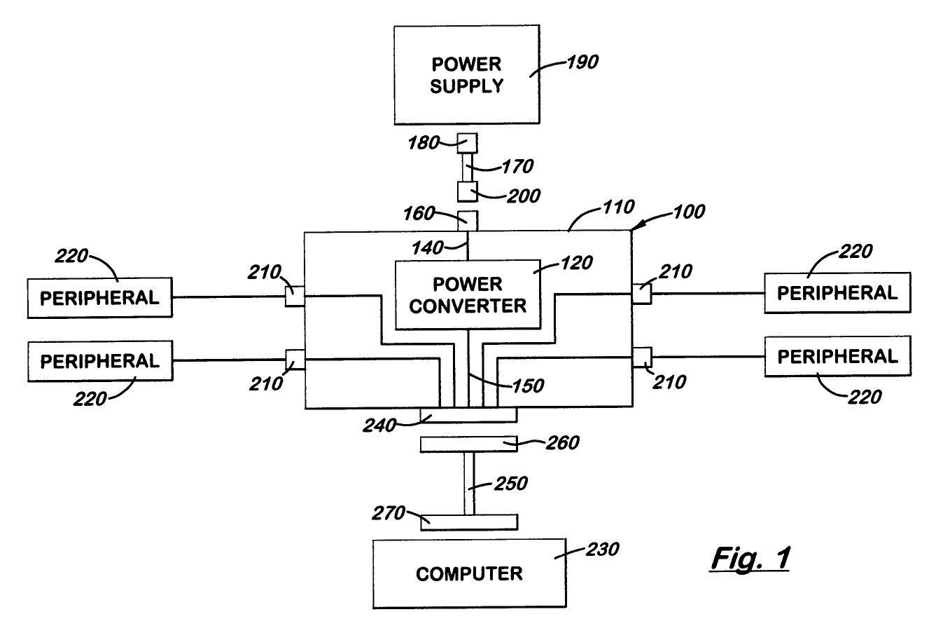

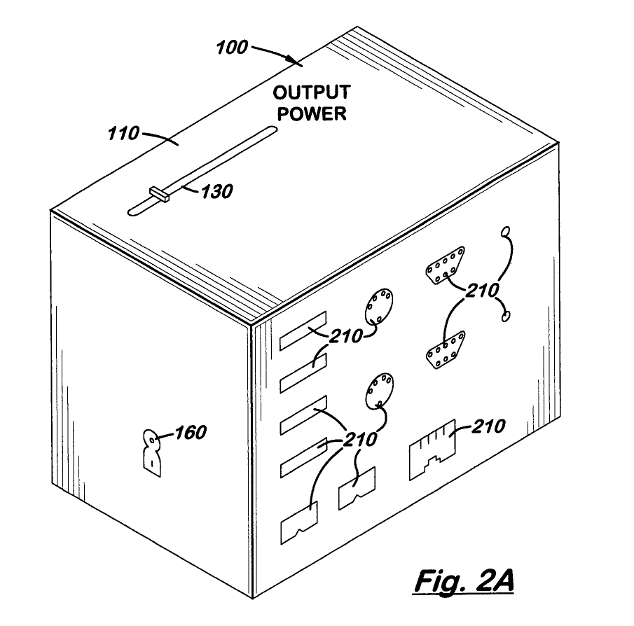

The present invention is a remote docking station 100, shown in block diagram form in FIG. 1. Within the docking station body 110, there is a power converter 120, known in the art. The power converter 120 can be an AC to DC converter or a DC to DC converter. For example, the AC to DC converter could transform 120V, 60 Hz AC power, typical in the United States, to 19V DC power. Alternately, the power converter could convert 12V DC power, typically supplied in automobiles, to 19V DC power. However, it is understood that the power converter 120 can be configured to convert any available power input to any required power output. In various embodiments of the invention, the output power level is variable and can be selected by the user. A variable and selectable power output 130, shown in FIGS. 2A and 2B, makes the present invention more universal and therefore the same unit can be used with a number of different computer systems.

The power converter 120 has an input side 140 and an output side 150. The input side 140 of power converter 120 is in electrical communication with an externally accessible power input connector interface 160. The power input connector interface 160 is configured to connect to a power input cable 170.

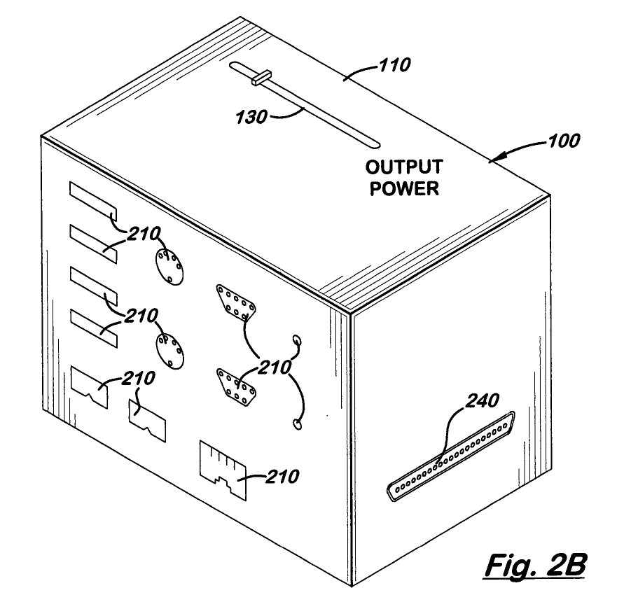

The power input cable 170, shown in FIG. 3, can be any desired length and has two ends. A first power input cable end 180 is configured to connect to a power supply 190, such as a standard electrical socket or an automobile power supply socket. A second power input cable end 200 is configured to connect to the power input connector interface 160. When fully connected, the power input cable 170 delivers electrical power from the power supply 190 to the input side 140 of the power converter 120.

The present invention also has at least one externally accessible peripheral connector interface 210, shown in FIGS. 2A and 2B. Peripheral connector interfaces 210 are used to connect peripheral devices 220, such as keyboards, scanners, printers, pointing devices, microphones, speakers, video displays, digital cameras, portable music devices, or other devices to a computer 230. The peripheral connector interface or interfaces 220 can be any number or combination of network inputs, modem inputs, serial inputs, parallel inputs, universal serial bus (USB) inputs, PS2 inputs, IEEE 1394 inputs, video inputs, video outputs, audio inputs, audio outputs and or other inputs and outputs known in the art.

The number and combination of the peripheral connector interfaces 210 in a specific embodiment of the present invention could be determined by a producer of the invention. The producer could offer a variety of models that offer different numbers and combinations of peripheral connector interfaces 210 so as to meet the needs of the user.

The peripheral connector interfaces 210 are in electrical communication with an externally accessible output connector interface 240. The output connector interface 240 is also in electrical communication with the output side 150 of the power converter 120. Thus, there is a single connector, the output connector interface 240, to supply electrical power and the electrical signals from the peripheral devices 220 to the computer 230.

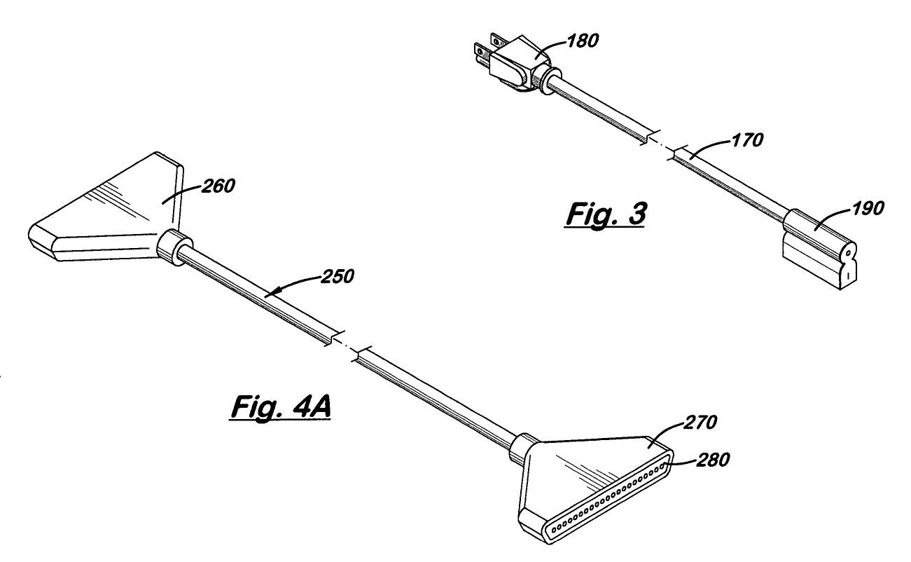

To connect the output connector interface 240 to the computer 230, there is a multipurpose interface cable 250. The multipurpose interface cable 250 can be of any desired length and has two ends. One end of this cable, the first multipurpose interface cable end 260, is configured to connect to the output connector interface 240. The other end of this cable, the second multipurpose interface cable end 270, can have a variety of configurations. A preferred configuration of the second multipurpose interface cable end 270 is configured to have a single multipurpose connection interface 280, shown in FIG. 4A, to connect to the computer 230, such as a portable computer. In this configuration, the user merely makes one connection, and the computer 230 is connected to the peripheral devices 220 as well as the power supply 190.

This configuration particularly reduces clutter on the user's workspace. All of the wires for the peripheral devices 220 and power supply 190 are kept off the workspace. In this configuration, only the multipurpose interface cable 240 is on the workspace.

In an alternate configuration of the present invention, the second multipurpose interface cable end 270 is configured to connect to the computer 230 via a plurality of conventional connection interfaces 290, shown in FIG. 4B. The plurality of conventional connection interfaces 290 could match the number and type of peripheral connector interfaces 210 plus a power connection interface 300 for supplying electrical power to the computer 230.

This embodiment provides much of the benefits of the previously described embodiment, in that the signals from the peripheral devices 220 and the power supply 190 are carried from the remote docking station 100 to the computer 230 via a single cable, the multipurpose interface cable 250. This configuration also makes the present invention more universal by using standardized conventional connection interfaces 290, as opposed to the multipurpose connection interface 280 that may not be standard to all computers.

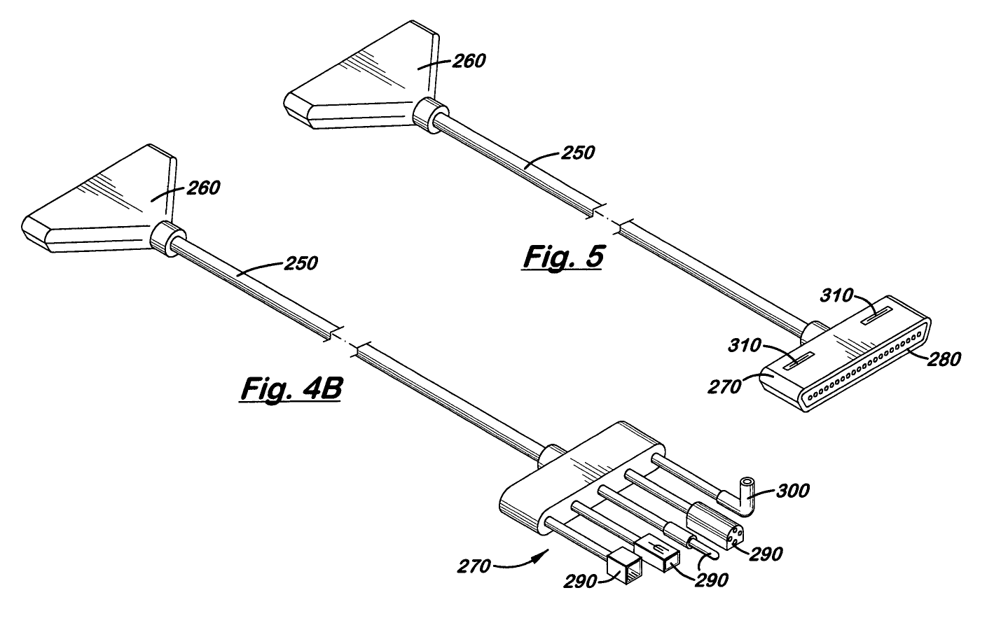

Whether configured to connect to the computer 230 via a single multipurpose connection interface 280 or a plurality of conventional connection interfaces 290, the second multipurpose interface cable end 270 may also have one or more auxiliary input interfaces 310, shown in FIG. 5. The auxiliary input interfaces 310 can be any of the type of peripheral connector interfaces 210 described above. An auxiliary input interface 310 can be used to quickly connect an additional peripheral device 220 that the user does not want or need to connect to the computer 230 through the remote docking station 100. When in use, the auxiliary input interface 310 receives an input signal from a peripheral device 220 and transmits the input signal to the computer 230. For example, a user may want to connect a portable music device, such as an MP3 player, via a USB interface, to the computer and quickly download music from the computer to the portable music device. The auxiliary input interface 310 allows the user to quickly and efficiently accomplish this task by bypassing the remote docking station 100.

One reason conventional remote docking stations may not utilize power converters 120 as a base for interfacing a number of different inputs is the problem of electromagnetic shielding (EMI). Electromagnetic interference (EMI) is an electrical noise which creates a disturbance or undesired response in an electrical system. It is understood that to effectively integrate a number of lines into the power converter 120, the amount of EMI disturbance may need to be controlled. The EMI may need to be shielded and the electromagnetic waves reduced by reflection and/or absorption. In various embodiments of the present invention, each wire which communicates an electrical signal for a particular peripheral connector interface 210 or auxiliary input interface 310 is optionally individually shielded against EMI, if needed. Accordingly, the remote docking station 100 of the present invention may contain EMI shielding. Additionally, the multipurpose interface cable 250 optionally contains EMI shielding.

While the specific embodiments have been illustrated and described, numerous modifications come to mind without significantly departing from the spirit of the invention, and the scope of protection is only limited by the scope of the accompanying claims.

1. A remote docking station apparatus comprising:
a remote docking station body,
a power converter contained within said remote docking station body, wherein said power converter has an input side and an output side,
an externally accessible power input connector interface, said power input connector interface configured to connect to a power input cable and is in electrical communication with said input side of said power converter,
at least one externally accessible peripheral connector interface,
an externally accessible output connector interface, wherein said output connector interface is in electrical communication with said output side of said power converter and is in electrical communication with each of said at least one peripheral connector interface; and
a multipurpose interface cable configured to connect said output connector interface to a computer.

2. The remote docking station of claim 1, wherein said computer is a portable computer.

3. The remote docking station of claim 1, wherein said power input cable comprises:
a first power input cable end configured to connect to a power supply source; and
a second power input cable end configured to connect to said power input connector interface.

4. The remote docking station of claim 3, wherein said first power input cable end is configured to connect to a standard electrical socket.

5. The remote docking station of claim 3, wherein said first power input cable end is configures to connect to an automotive power supply socket.

6. The remote docking station of claim 1, wherein said power converter comprises:
means for selecting a power output level,
said selecting means being externally accessible to said remote docking station body.

7. The remote docking station of claim 1, wherein said power converter comprises an AC to DC power converter.

8. The remote docking station of claim 7, wherein said AC to DC power converter further comprises:
means for selecting a DC power output level,
said selecting means being externally accessible to said remote docking station body.

9. The remote docking station of claim 1, wherein said power converter comprises a DC to DC power converter.

10. The remote docking station of claim 9, wherein said DC to DC power converter further comprises:
means for selecting a DC power output level,
said selecting means being externally accessible to said remote docking station body.

11. The remote docking station of claim 1, wherein said multipurpose interface cable comprises:
a first multipurpose interface cable end configured to connect to said output connector interface, and
a second multipurpose interface cable end configured to connect to said computer.

12. The remote docking station of claim 11, wherein said second multipurpose interface cable end is configured to connect to said computer via a single multipurpose connection interface.

13. The remote docking station of claim 11, wherein said second multipurpose interface cable end is configured to connect to said computer via a plurality of conventional connection interfaces.

14. The remote docking station of claim 11, wherein said second multipurpose interface cable end comprises at least one auxiliary input interface configured to receive an input signal and transmit said input signal to said computer.

15. The remote docking station of claim 1, wherein said multipurpose interface cable comprises electromagnetic interference shielding configured to prevent electromagnetic interference from affecting electric signals in said multipurpose interface cable.

16. The remote docking station of claim 1, further comprising electromagnetic interference shielding inside said docking station body configured to prevent electromagnetic interference from affecting electric signals in said docking station body.

17. The remote docking station of claim 1, wherein said at least one peripheral connector interface is configured to receive a network input.

18. The remote docking station of claim 1, wherein said at least one peripheral connector interface is configured to receive a modem input.

19. The remote docking station of claim 1, wherein said at least one peripheral connector interface is configured to receive a serial input.

20. The remote docking station of claim 1, wherein said at least one peripheral connector interface is configured to receive a parallel input.

21. The remote docking station of claim 1, wherein said at least one peripheral connector interface is configured to receive a USB input.

22. The remote docking station of claim 1, wherein said at least one peripheral connector interface is configured to receive a PS2 input.

23. The remote docking station of claim 1, wherein said at least one peripheral connector interface is configured to receive a IEEE 1394 input.

24. The remote docking station of claim 1, wherein said at least one peripheral connector interface is configured to receive a video input.

25. The remote docking station of claim 1, wherein said at least one peripheral connector interface is configured to receive an audio input.

26. The remote docking station of claim 1, wherein said at least one peripheral connector interface is configured to receive a video output.

27. The remote docking station of claim 1, wherein said at least one peripheral connector interface is configured to receive an audio output.
